(19) United States
(12) Patent Application Publication
(10) Pub. No.: US 2026/0241624 A1
(43) Pub. Date: Aug. 20, 2026

(54) METHOD FOR MANUFACTURING INSERT MOLDED ARTICLE, MOLD FOR INSERT MOLDING, AND INSERT MOLDED ARTICLE

(71) Applicant: YAZAKI CORPORATION, Tokyo (JP)

(72) Inventors: Shoya Sugiyama, Makinohara-shi (JP); Kazuhiro Tsuchida, Makinohara-shi (JP); Tomohiro Shibata, Makinohara-shi (JP)

(21) Appl. No.: 19/530,374

(22) Filed: Feb. 5, 2026

(30) Foreign Application Priority Data
Feb. 19, 2025 (JP) 2025-024836

(51) Int. Cl. B29C 45/14; B29K 705/00

(52) U.S. Cl. CPC B29C 45/14065; B29C 45/14598; B29C 2045/14122; B29K 2705/00

(57) ABSTRACT

A method for manufacturing an insert molded article includes an inserting step of disposing a metal collar including a cylinder portion in a first mold such that an axis of the cylinder portion is along a mold clamping direction, a mold clamping step of clamping a second mold including a pressing protrusion to be in contact with and press an end surface of the cylinder portion, and the first mold to form a locking protrusion on an outer circumference (an outer circumferential surface) of the cylinder portion by the pressing protrusion, and a molding step of filling a cavity formed around the cylinder portion by the first mold and the second mold clamped at the mold clamping step with a resin.

### CROSS-REFERENCE TO RELATED APPLICATION(S)

The present application claims priority to and incorporates by reference the entire contents of Japanese Patent Application No. 2025-024836 filed in Japan on February 19, 2025.

### BACKGROUND OF THE INVENTION

### Field of the Invention

The present invention relates to a method for manufacturing an insert molded article, a mold for insert molding, and an insert molded article.

### Description of the Related Art

As conventional technologies related to a method for manufacturing an insert molded article, a mold for insert molding, and an insert molded article, for example, JP 2004 – 042 561 A discloses a method for manufacturing an insert molded article, a mold for insert molding, and an insert molded article in which after a collar made of a metallic material having easily deformable portions formed at both ends is set in a mold, an upper mold and a lower mold are brought close to each other to crush the easily deformable portions, and molding is performed with a flat surface formed by the crushing of the easily deformable portions being in close contact with the upper mold or the lower mold.

By the way, such a method for manufacturing an insert molded article, a mold for insert molding, and an insert molded article may be configured such that, for example, the outer circumference of the metal collar is subjected to knurling or the like to prevent it from easily coming loose from a resin molded portion. In addition, there is room for further improvement in the configuration for assembling the metal collar to the resin molded portion.

### SUMMARY OF THE INVENTION

The present invention has been made in view of the above circumstances, and an object thereof is to provide a method for manufacturing an insert molded article, a mold for insert molding, and an insert molded article that can properly assemble a metal collar to a resin molded portion.

In order to achieve the above mentioned object, a method for manufacturing an insert molded article according to one aspect of the present invention includes an insert step of disposing a metal collar including a tube portion in a first mold such that an axis of the tube portion is along a mold clamping direction; a mold clamping step of clamping a second mold including a pressing protrusion to be in contact with and press an end surface of the tube portion, and the first mold to form a locking protrusion on an outer circumference of the tube portion by the pressing protrusion; and a molding step of filling a cavity formed around the tube portion by the first mold and the second mold clamped at the clamping with a resin.

In order to achieve the above mentioned object, a mold for insert molding according to another aspect of the present invention includes a first mold including a placing surface on which an end surface of a metal collar on one side is placed such that an axis of a tube portion of the metal collar including the tube portion is along a mold clamping direction, and a first cavity forming surface adjacent to the placing surface; and a second mold including an insertion portion formed in a columnar shape and to be inserted into an inside of the tube portion, a collar end surface contact surface provided outside the insertion portion in a radial direction and to be in contact with an end surface of the metal collar on another side, a pressing protrusion protruding from the collar end surface contact surface to be in contact with and press the end surface of the tube portion on the other side, and a second cavity forming surface adjacent to the collar end surface contact surface, wherein the first cavity forming surface being formed shallower than the placing surface, and the second cavity forming surface being formed shallower than the collar end surface contact surface.

In order to achieve the above mentioned object, an insert molded article according to still another aspect of the present invention includes a metal collar including a tube portion; and a resin molded portion to which the metal collar is assembled, wherein the tube portion including a recessed portion recessed from an end surface of the tube portion and an outer circumferential surface of the tube portion, and a locking protrusion protruding from the recessed portion outward in a radial direction of the tube portion to bite into the resin molded portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an insert molded article according to an embodiment viewed from above;

FIG. 2 is a perspective view of the insert molded article according to the embodiment viewed from below;

FIG. 3 is a III-III sectional view of FIG. 1;

FIG. 4 is a IV-IV sectional view of FIG. 1;

FIG. 5 is a perspective view of a metal collar assembled to the insert molded article according to the embodiment;

FIG. 6 is a sectional view corresponding to the III-III section of FIG. 1, illustrating a state in which a first mold and a second mold of a mold for insert molding according to the embodiment are separated from each other and the metal collar is disposed in the first mold;

FIG. 7 is a perspective view of a metal collar support portion of the first mold according to the embodiment;

FIG. 8 is a perspective view of a piece member of the second mold according to the embodiment;

FIG. 9 is a perspective view of an insertion portion forming recessed portion and the piece member of the second mold according to the embodiment;

FIG. 10 is a flow diagram of a method for manufacturing an insert molded article according to the embodiment;

FIG. 11 is a sectional view corresponding to the III-III section of FIG. 1, representing a state in which the mold for insert molding according to the embodiment is clamped to form a cavity; and

FIG. 12 is a sectional view corresponding to the IV-IV section of FIG. 1, representing a state in which the mold for insert molding according to the embodiment is clamped to form the cavity.

### DETAILED DESCRIPTION OF THE PREFERRED EMBODIMENTS

An embodiment according to the present invention will be described below in detail based on the accompanying drawings. Note that the present invention is not limited by this embodiment. In addition, the components in the following embodiment include ones that are replaceable and easy by those skilled in the art or substantially the same ones.

### Embodiment

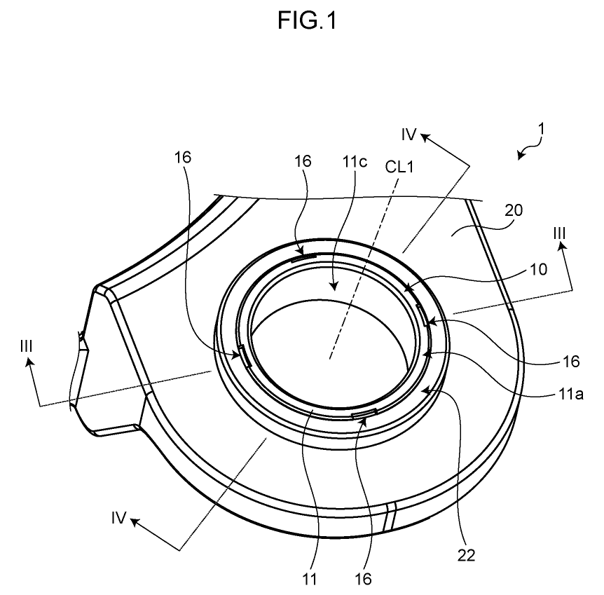

This insert molded article 1 of the present embodiment illustrated in FIG. 1 to FIG. 4 can be, for example, a protector incorporated into a wire harness that is routed to a vehicle such as an automobile. Here, the wire harness, for example, bundles a plurality of routing materials used for power supply and signal communication to make a collective component for connections between devices installed in the vehicle, and connects the routing materials to the devices with connectors or the like. The routing material is, for example, an insulated wire in which a core wire including a plurality of conductive metal wires bundled together is covered with an insulated covering portion. The routing material may be a bundle of a plurality of insulated wires. The protector, which is the insert molded article 1, protects the routing materials routed inside, and is fixed to the vehicle to regulate a routing path for the routing materials.

The protector as the insert molded article 1 includes a metal collar 10 and a resin molded portion 20 that serves as a protector body with the metal collar 10 assembled. The metal collar 10 is made of, for example, a conductive metal material, and is formed in a substantially cylindrical shape around an axis CL1. The metal collar 10 includes a cylinder portion 11 (a tube portion) formed in a substantially cylindrical shape, and a flange portion 12 formed on the outer circumference of the cylinder portion 11 at an end of the cylinder portion 11 on one side in the direction of the axis CL1.

Note that the following description will be given with one side of the metal collar 10 in the direction of the axis CL1 as a lower side and the other side as an upper side.

Although not illustrated, for example, a round terminal of a ground terminal is brought into contact with an upper end surface 11a of the cylinder portion 11 of the metal collar 10, a lower end surface 11b (a lower surface 12b of the flange portion 12) is brought into contact with the body of the vehicle or the like, a bolt is inserted into the cylinder portion 11, and thus the insert molded article 1 is fixed to the body of the vehicle or the like together with the ground terminal. This electrically connects the ground terminal to the body of the vehicle or the like via the metal collar 10. The end surface 11a and the end surface 11b of the cylinder portion 11 (the lower surface 12b of the flange portion 12) are formed in a flat surface shape.

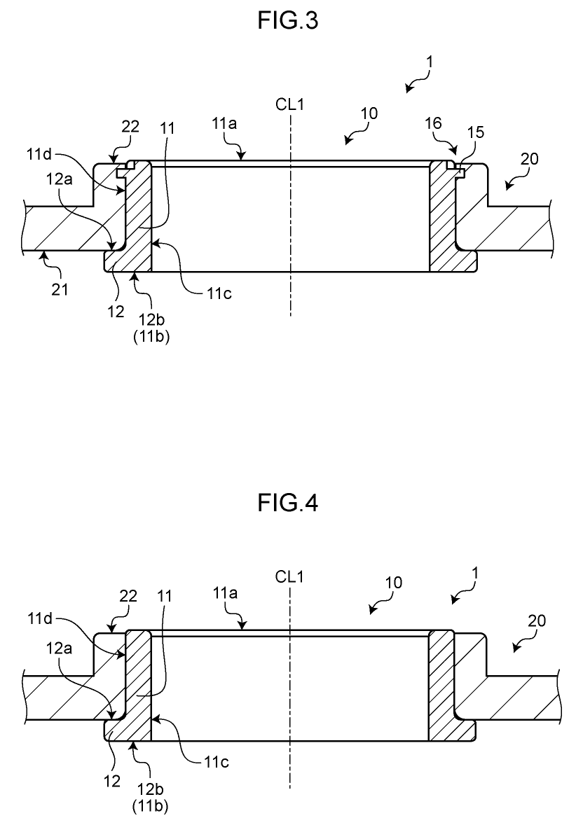

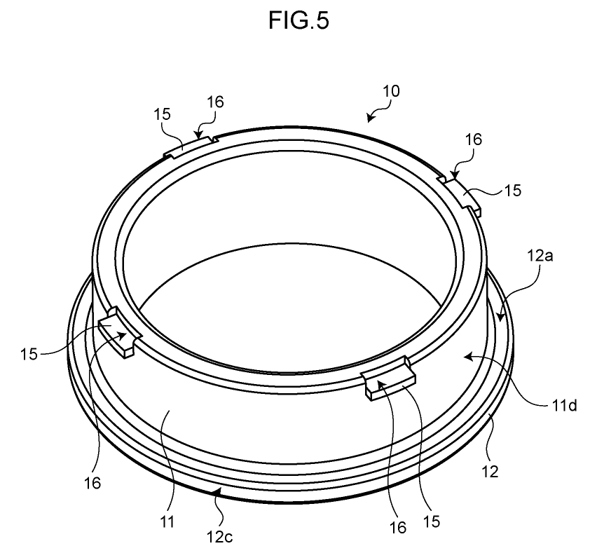

As illustrated in FIG. 3 to FIG. 5, the upper end surface 11a of the cylinder portion 11 of the metal collar 10 is formed in a substantially annular, flat surface shape. An outer circumferential surface 11d of the cylinder portion 11 closer to the end surface 11a (that is, the outer circumference of the cylinder portion 11) is provided with four locking protrusions 15 at equal intervals around the axis CL1 of the metal collar 10. The locking protrusions 15 protrude outward in the radial direction of the cylinder portion 11 (in other words, outward in a direction orthogonal to and crossing the axis CL1) from the lower side (bottom side) of recessed portions 16 recessed from the end surface 11a of the cylinder portion 11 and the outer circumferential surface 11d of the cylinder portion 11.

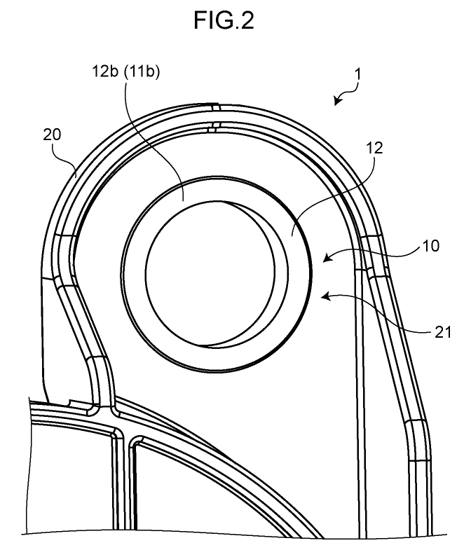

As illustrated in FIG. 2 and FIG. 4, an upper surface 12a of the flange portion 12 of the metal collar 10 is in contact with a lower surface 21 of the resin molded portion 20. The flange portion 12 is exposed from the lower surface 21 of the resin molded portion 20. The flange portion 12 prevents the metal collar 10 from coming loose in the upward direction.

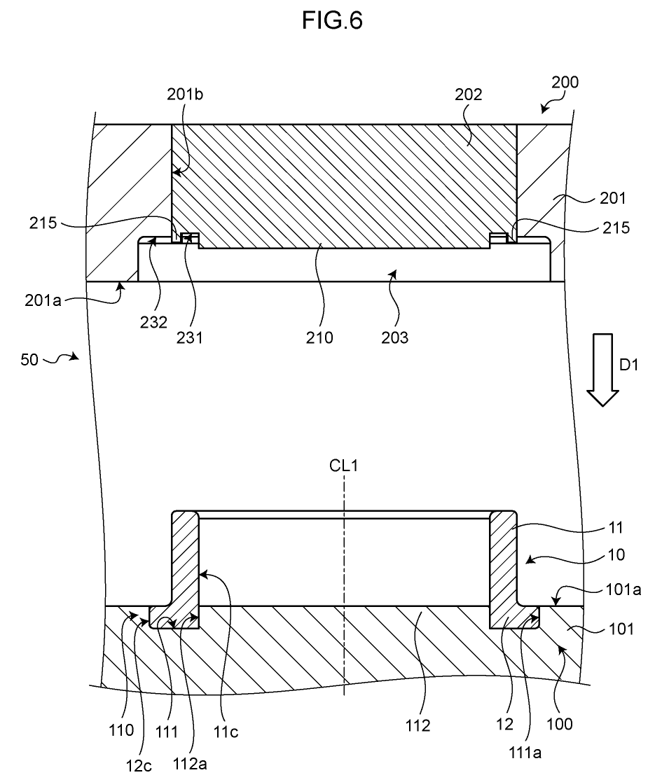

As illustrated in FIG. 6, a mold 50 for insert molding for manufacturing the insert molded article 1 includes a first mold 100 and a second mold 200. The mold 50 for insert molding can, for example, dispose the first mold 100 on the lower fixed side and dispose the second mold 200 on the upper movable side in a vertical injection molding machine. The first mold 100 and the second mold 200 relatively approach each other to be clamped and relatively separate from each other to be opened. Specifically, the second mold 200 moves from the upper side to the lower side to be clamped as illustrated in a mold clamping direction D1, and moves in a direction opposite to the mold clamping direction D1, that is, from the lower side to the upper side to be opened.

The first mold 100 includes a first mold body 101 and a metal collar support portion 110 provided in the first mold body 101. The upper surface of the first mold body 101 is formed in a flat surface shape to be a first cavity forming surface 101a. The metal collar support portion 110 and an insertion portion forming recessed portion 203 and a piece member 202 of the second mold 200 described below are concentrically disposed. The metal collar support portion 110 supports the metal collar 10 including the cylinder portion 11. The metal collar support portion 110 is provided in the first cavity forming surface 101a of the first mold body 101.

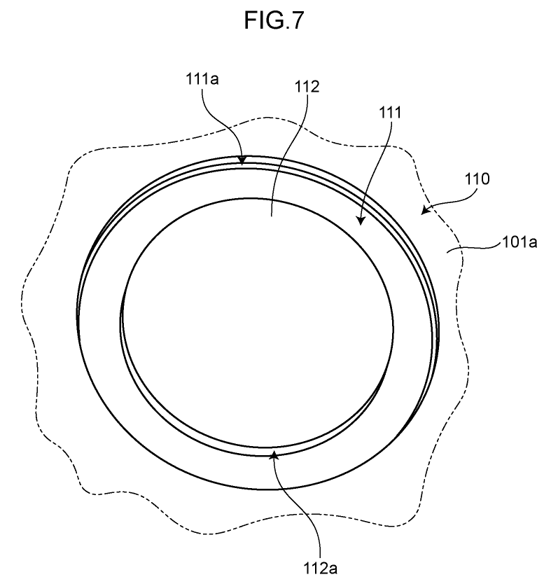

Specifically, as illustrated in FIG. 6 and FIG. 7, the metal collar support portion 110 includes a placing surface 111 in contact with the lower end surface 11b of the cylinder portion 11 of the metal collar 10 (the lower surface 12b of the flange portion 12). The placing surface 111 is formed as a bottom surface in an annular recessed groove. In the inside of the placing surface 111, a collar support column 112 formed in a thin, cylindrical shape is formed. The collar support column 112 is inserted into the cylinder portion 11 from the underside of the metal collar 10. An outer circumferential surface 112a of the collar support column 112 is in contact with an inner circumferential surface 11c of the metal collar 10. An annular circumferential surface 111a erected on the outer edge of the placing surface 111 is in contact with an outer circumferential surface 12c of the flange portion 12 of the metal collar 10. Therefore, the metal collar support portion 110 restricts the movement of the metal collar 10 in a direction horizontal to the first cavity forming surface 101a.

As illustrated in FIG. 6, the distance from the first cavity forming surface 101a to the placing surface 111 (that is, the depth of the placing surface 111) is made equal to the thickness of the flange portion 12 of the metal collar 10. In other words, the first cavity forming surface 101a is formed shallower than the placing surface 111. The first cavity forming surface 101a is provided outside the placing surface 111 in the radial direction, adjacent to the placing surface 111.

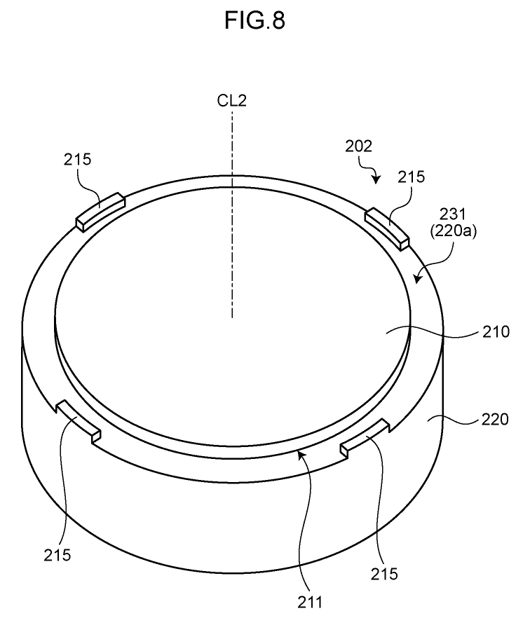

As illustrated in FIG. 6, the second mold 200 includes a second mold body 201 and the piece member 202 provided in the second mold body 201 in a detachable manner. The piece member 202 includes an insertion portion 210 to be inserted into the cylinder portion 11 of the metal collar 10. More specifically, as illustrated in FIG. 8, the piece member 202 includes a piece member body 220 formed in a substantially cylindrical shape that is a columnar shape. The insertion portion 210 is formed in a thin, substantially columnar, substantially cylindrical shape protruding from a lower surface 220a of the piece member body 220 on one side (the lower side). The vertical thickness of the insertion portion 210 is formed sufficiently thinner than the vertical thickness of the piece member body 220. The axis of the insertion portion 210 is made concentric with the axis of the piece member body 220. The diameter of the insertion portion 210 is made smaller than the diameter of the piece member body 220. Therefore, the lower surface 220a of the piece member 202 (also the lower surface of the piece member body 220) is annularly exposed around a base portion 211 of the insertion portion 210. The annularly exposed portion of the lower surface 220a is a collar end surface contact surface 231.

The piece member 202 is provided with a pressing protrusion 215 protruding downward from the collar end surface contact surface 231. Four pressing protrusions 215 are provided at equal intervals around an axis CL2 of the piece member 202, outside the insertion portion 210. The pressing protrusions 215 are formed protruding from the collar end surface contact surface 231. In the present embodiment, the pressing protrusions 215 are provided along the outer edge of the collar end surface contact surface 231 of the piece member 202. Therefore, the outer surfaces of the pressing protrusions 215 in the radial direction are continuous with the outer circumferential surface of the piece member body 220.

The pressing protrusion 215 is formed in an arc shape following the outer edge of the circular collar end surface contact surface 231 (that is, the outer edge of the end surface 11a of the cylinder portion 11 of the metal collar 10) when viewed from the direction of the axis CL2. With this, at a mold clamping step (Step S2) described below, the entire lower surface of the pressing protrusion 215 can be brought into contact with and press the outer edge of the end surface 11a of the cylinder portion 11, and the locking protrusion 15 can be formed using the entire pressing protrusion 215.

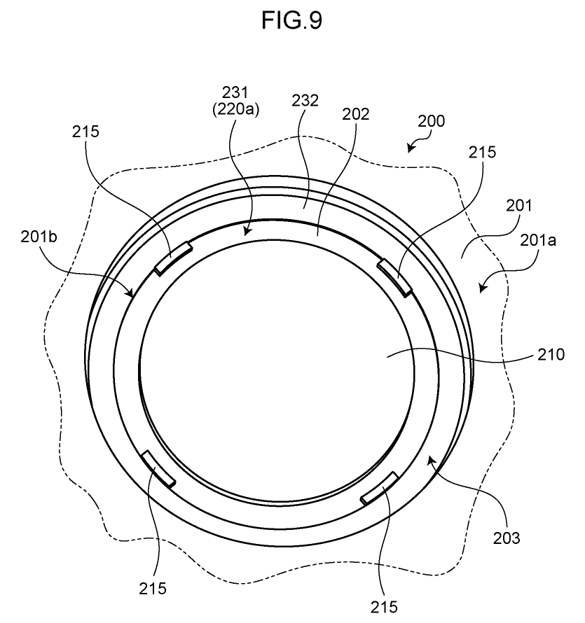

Referring back to FIG. 6, the lower surface of the second mold body 201 is formed in a flat surface shape to be a cavity surface 201a. The second mold body 201 is provided with a mounting hole 201b passing therethrough circularly so that the piece member 202 is assembled. The piece member 202 is assembled to the mounting hole 201b in a detachable manner. As illustrated in FIG. 6 and FIG. 9, the circular insertion portion forming recessed portion 203 formed in a recessed shape from the cavity surface 201a is provided under the mounting hole 201b. The insertion portion forming recessed portion 203 is disposed concentrically with the mounting hole 201b. The diameter of the insertion portion forming recessed portion 203 is formed larger than the mounting hole 201b.

In the insertion portion forming recessed portion 203, an annular second cavity forming surface 232 is formed outside the collar end surface contact surface 231 of the piece member 202 in the radial direction, adjacent to the collar end surface contact surface 231. A cavity 250 includes the second cavity forming surface 232. The second cavity forming surface 232 is formed in a flat surface shape. The second cavity forming surface 232 is formed slightly shallower than the collar end surface contact surface 231 of the piece member 202. The second cavity forming surface 232 is formed shallower than the collar end surface contact surface 231 to the extent that the upper end surface 11a of the metal collar 10 protrudes slightly from an upper surface 22 of the resin molded portion 20 after molding.

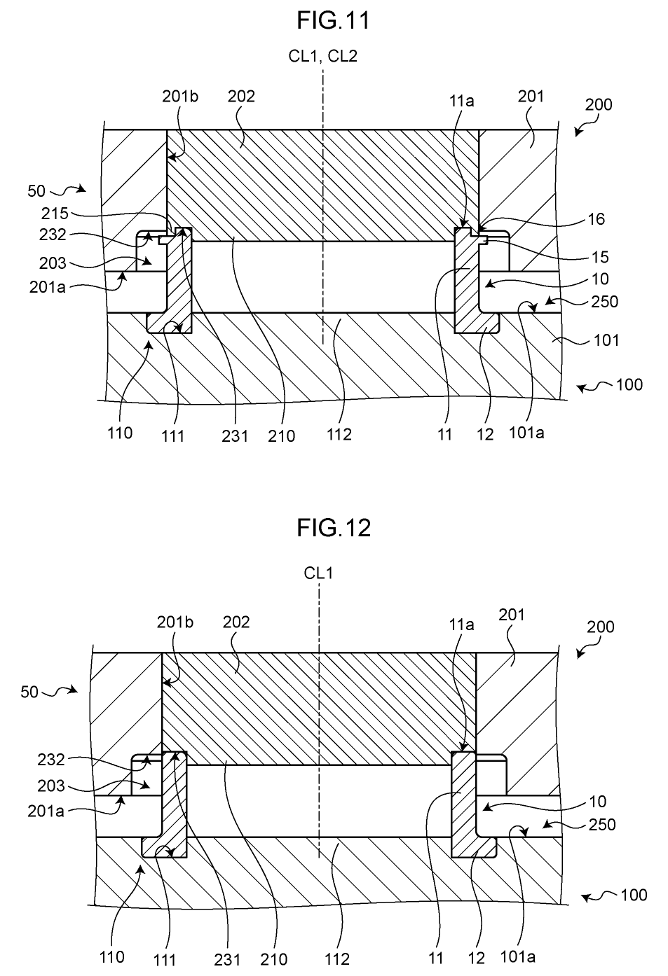

The first mold 100 and the second mold 200 each include a not-illustrated parting surface. The first mold 100 and the second mold 200 are clamped by making them relatively approach each other to bring their parting surfaces into contact with each other. When the first mold 100 and the second mold 200 are clamped, the cavity 250, which is a closed space, is formed around the cylinder portion 11 of the metal collar 10 by cavity forming surfaces including the first cavity forming surface 101a of the first mold 100 and the cavity surface 201a and the second cavity forming surface 232 of the second mold 200 (refer to FIG. 11 and FIG. 12).

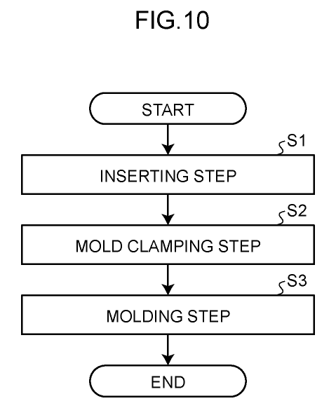

As illustrated in FIG. 10, a method for manufacturing an insert molded article for manufacturing the insert molded article 1 using the mold 50 for insert molding includes an inserting step (Step S1), the mold clamping step (Step S2), and a molding step (Step S3).

Inserting step (Step S1); As illustrated in FIG. 6, at the inserting step (Step S1), the mold 50 for insert molding is opened, and the metal collar 10 is disposed in the first mold 100 such that the axis CL1 of the cylinder portion 11 is along the mold clamping direction D1. Specifically, the metal collar 10 is disposed in the metal collar support portion 110 of the first mold 100 with the flange portion 12 facing the first mold 100. At this time, the lower surface 12b of the flange portion 12 is in contact with the placing surface 111 of the metal collar support portion 110, and the collar support column 112 is inserted into the inner circumferential surface 11c of the cylinder portion 11 of the metal collar 10. The upper surface 12a of the flange portion 12 of the metal collar 10 is disposed so as to be substantially continuous with the first cavity forming surface 101a of the first mold 100.

Mold clamping step (Step S2); At the mold clamping step (Step S2), after the inserting step (Step S1), the second mold 200 is moved in the mold clamping direction D1 to clamp the first mold 100 and the second mold 200, as illustrated in FIG. 11 and FIG. 12. By clamping the first mold 100 and the second mold 200, the insertion portion 210 of the second mold 200 is inserted into the inner circumferential surface 11c of the cylinder portion 11 of the metal collar 10. At this time, the pressing protrusions 215 of the second mold 200 are in contact with and press the end surface 11a of the cylinder portion 11 of the metal collar 10. The pressing protrusions 215 are in contact with the outer edge portion of the end surface 11a. When the respective parting surfaces (not illustrated) of the first mold 100 and the second mold 200 are brought into contact with each other and the mold clamping is completed, pressing by the pressing protrusions 215 forms the locking protrusions 15 and the recessed portions 16 in the cylinder portion 11 of the metal collar 10. When the mold clamping is completed, the collar end surface contact surface 231 is in contact with the end surface 11a of the cylinder portion 11.

That is, the mold clamping step (Step S2) clamps the first mold 100 and the second mold 200 to insert the insertion portion 210 into the inside of the cylinder portion 11 and to form the four locking protrusions 15 by the four pressing protrusions 215. The mold clamping step (Step S2) presses the outer circumferential edge of the end surface 11a of the cylinder portion 11 by the pressing protrusions 215 to form the recessed portions 16, and forms the locking protrusions 15 protruding from the recessed portions 16. The mold clamping step (Step S2) clamps the first mold 100 and the second mold 200 to bring the collar end surface contact surface 231 into contact with the end surface 11a of the cylinder portion 11.

Molding step (Step S3); As illustrated in FIG. 11 and FIG. 12, the molding step (Step S3) fills the cavity 250 formed around the cylinder portion 11 by the mold 50 for insert molding clamped at the mold clamping step (Step S2) with a resin.

After the completion of the molding step (Step S3), the second mold 200 is raised to open the first mold 100 and the second mold 200, and the molded insert molded article 1 is taken out of the first mold 100. In this way, the insert molded article 1 can be obtained by the method for manufacturing an insert molded article using the mold 50 for insert molding.

The method for manufacturing an insert molded article described above includes the inserting step (Step S1) of disposing the metal collar 10 including the cylinder portion 11 as the tube portion in the first mold 100 such that the axis CL1 of the cylinder portion 11 is along the mold clamping direction D1, the mold clamping step (Step S2) of clamping the second mold 200 including the pressing protrusion 215 to be in contact with and press the end surface 11a of the cylinder portion 11, and the first mold 100 to form the locking protrusion 15 on the outer circumference (the outer circumferential surface 11d) of the cylinder portion 11 by the pressing protrusion 215, and the molding step (Step S3) of filling the cavity 250 formed around the cylinder portion 11 by the first mold 100 and the second mold 200 clamped at the mold clamping step (Step S2) with the resin.

With this, in the insert molded article 1, the locking protrusion 15 protruding from the cylinder portion 11 of the metal collar 10 is caused to bite into the resin molded portion 20, thereby enabling the metal collar 10 to be assembled to the resin molded portion 20. Therefore, the metal collar 10 is surely prevented from coming loose in the vertical direction owing to the locking protrusion 15 biting into the resin molded portion 20. For example, with the insert molded article 1 as the protector provided in the wire harness installed in the vehicle, the metal collar 10 is fastened to the body of the vehicle together with the ground terminal by the bolt. Also in this case, the insert molded article 1 reduces the possibility of the metal collar 10 easily coming loose from the resin molded portion 20 due to vibration or the like during tightening the bolt or driving the vehicle. Thus, the method for manufacturing an insert molded article of the present embodiment can properly assemble the metal collar 10 to the resin molded portion 20.

That is, according the present embodiment, even when, for example, insert molding that assembles a metal collar of a known form including the cylinder portion 11 and the flange portion 12 to the resin molded portion 20 is performed, the insert molded article 1 in which the metal collar 10 is prevented from coming loose from the resin molded portion 20 can be obtained. Therefore, there is no need to separately perform processing such as knurling on the metal collar.

The second mold 200 includes the insertion portion 210 formed in a cylindrical shape that is a columnar shape and to be inserted into the inside of the cylinder portion 11, a plurality of pressing protrusions 215 are provided at intervals around the axis CL2 (that is, the axis CL1) outside the insertion portion 210, and the mold clamping step (Step S2) clamps the first mold 100 and the second mold 200 to insert the insertion portion 210 into the inside of the cylinder portion 11 and to form a plurality of locking protrusions 15 by the pressing protrusions 215. With this, the insertion portion 210 is inserted into the cylinder portion 11 to restrict its movement in a direction parallel to the plane orthogonal to the axis CL1, thereby positioning the metal collar 10. In particular, the upper side of the cylinder portion 11 is positioned. The pressing protrusions 215 are in contact with and press the cylinder portion 11 of the positioned metal collar 10, and the locking protrusions 15 can be formed. Since the cylinder portion 11 is supported by the insertion portion 210, pressing of the end surface 11a by the pressing protrusions 215 is ensured.

The metal collar 10 includes the flange portion 12 formed on the outer circumference of the cylinder portion 11, and the inserting step (Step S1) disposes the metal collar 10 with the flange portion 12 facing the first mold 100. With this, the flange portion 12 can be used to prevent one side of the metal collar 10 incorporated into the resin molded portion 20 from coming loose.

The pressing protrusion 215 is provided so as to be in contact with and press the outer circumferential edge of the end surface 11a of the cylinder portion 11, and the mold clamping step (Step S2) presses the outer circumferential edge of the end surface 11a of the cylinder portion 11 by the pressing protrusion 215 to form the recessed portion 16, and forms the locking protrusion 15 protruding from the recessed portion 16. With this, the locking protrusion 15 can be formed by, for example, shaving the cylinder portion 11 from the outer circumferential edge of the end surface 11a of the cylinder portion 11 by the pressing protrusion 215. In other words, the locking protrusion 15 can be formed in a chip-forming manner. Therefore, the force applied to the pressing protrusion 215 can be reduced, and the life of the mold (the piece member 202) can be made longer.

The second mold 200 includes the collar end surface contact surface 231 to be in contact with the end surface 11a of the cylinder portion 11, and the second cavity forming surface 232 adjacent to the collar end surface contact surface 231 and forming the cavity 250, the second cavity forming surface 232 is formed shallower than the collar end surface contact surface 231, the pressing protrusion 215 is formed protruding from the collar end surface contact surface 231, the mold clamping step (Step S2) clamps the first mold 100 and the second mold 200 to bring the collar end surface contact surface 231 into contact with the end surface 11a of the cylinder portion 11, and the molding step (Step S3) fills the cavity 250 including the second cavity forming surface 232 with the resin. With this, the end surface 11a of the cylinder portion 11 is caused to protrude from the upper surface 22 of the resin molded portion 20, and, for example, the ground terminal can be securely brought into contact with the end surface 11a.

The mold 50 for insert molding includes the first mold 100 including the placing surface 111 on which the end surface (the lower surface 12b) of the metal collar 10 on the lower side that is one side is placed such that the axis CL1 of the cylinder portion 11 of the metal collar 10 including the cylinder portion 11 is along the mold clamping direction D1, and the first cavity forming surface 101a adjacent to the placing surface 111, and the second mold 200 including the insertion portion 210 formed in a columnar shape and to be inserted into the inside of the cylinder portion 11, the collar end surface contact surface 231 provided outside the insertion portion 210 in the radial direction and to be in contact with the end surface 11a of the metal collar on the upper side that is the other side, the pressing protrusion 215 protruding from the collar end surface contact surface 231 to be in contact with and press the end surface 11a of the cylinder portion 11, and the second cavity forming surface 232 adjacent to the collar end surface contact surface 231, in which the first cavity forming surface 101a is formed shallower than the placing surface 111, and the second cavity forming surface 232 is formed shallower than the collar end surface contact surface 231. This can gain the mold 50 for insert molding that can manufacture the insert molded article 1 in which the locking protrusion 15 is formed so as to bite into and be locked into the resin molded portion 20, and the metal collar 10 is properly assembled to the resin molded portion 20 so that the upper and lower end portions are surely exposed.

The second mold 200 includes the piece member 202 including the insertion portion 210, the collar end surface contact surface 231, and the pressing protrusion 215, and the second mold body 201 provided with the piece member 202 in a detachable manner and including the second cavity forming surface 232. With this, even if the pressing protrusion 215 wears out, it only needs to be replaced with a new piece member 202, thus eliminating the need to newly fabricate the entire second mold 200.

The insert molded article 1 includes the metal collar 10 including the cylinder portion 11, and the resin molded portion 20 to which the metal collar 10 is assembled, in which the cylinder portion 11 includes the recessed portion 16 recessed from the end surface 11a of the cylinder portion 11 and the outer circumferential surface 11d of the cylinder portion 11, and the locking protrusion 15 protruding from the recessed portion 16 outward in the radial direction of the cylinder portion 11 to bite into the resin molded portion 20. With this, the locking protrusion 15 is locked into the resin molded portion 20 to be prevented from coming loose in the direction of the axis CL1, thereby making the insert molded article 1 in which the metal collar 10 is properly assembled to the resin molded portion 20.

Note that the method for manufacturing an insert molded article, the mold for insert molding, and the insert molded article according to the embodiment of the present invention described above are not limited to the embodiment described above, and various changes can be made within the scope described in the claims.

In the above description, the metal collar 10 is provided with the flange portion 12, but a metal collar without the flange portion 12 (that is, including only the cylinder portion 11) can also be used. The metal collar 10 is formed in a substantially cylindrical shape and includes the cylinder portion 11 in the present embodiment, but, for example, one formed in a substantially tubular shape, such as a substantially square tubular shape, can also be employed. One or a plurality of locking protrusions 15 can be provided. In the present embodiment, the piece member 202 is formed in the second mold 200 in a detachable manner to facilitate replacement of the piece member 202, but the insertion portion 210, the collar end surface contact surface 231, and the pressing protrusions 215 may be directly provided in the second mold body 201 of the second mold 200.

The method for manufacturing an insert molded article, the mold for insert molding, and the insert molded article according to the present embodiment may be configured by combining the components of the embodiment and the modifications described above as appropriate.

The method for manufacturing an insert molded article, the mold for insert molding, and the insert molded article according to the present embodiment have an effect of being capable of properly assembling the metal collar to the resin molded portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for manufacturing an insert molded article, the method comprising:
an insert step of disposing a metal collar including a tube portion in a first mold such that an axis of the tube portion is along a mold clamping direction;
a mold clamping step of clamping a second mold including a pressing protrusion to be in contact with and press an end surface of the tube portion, and the first mold to form a locking protrusion on an outer circumference of the tube portion by the pressing protrusion; and
a molding step of filling a cavity formed around the tube portion by the first mold and the second mold clamped at the clamping with a resin.

2. The method for manufacturing an insert molded article according to claim 1, wherein
the second mold includes an insertion portion formed in a columnar shape and to be inserted into an inside of the tube portion,
a plurality of the pressing protrusions are provided at intervals around the axis outside the insertion portion, and
the mold clamping step clamps the first mold and the second mold to insert the insertion portion into the inside of the tube portion and to form a plurality of the locking protrusions by the pressing protrusions.

3. The method for manufacturing an insert molded article according to claim 1, wherein
the metal collar includes a flange portion formed on the outer circumference of the tube portion, and
the insert step disposes the metal collar with the flange portion facing the first mold.

4. The method for manufacturing an insert molded article according to claim 1, wherein
the pressing protrusion is provided so as to be in contact with and press an outer circumferential edge of the end surface of the tube portion, and
the mold clamping step presses the outer circumferential edge of the end surface of the tube portion by the pressing protrusion to form a recessed portion, and forms the locking protrusion protruding from the recessed portion.

5. The method for manufacturing an insert molded article according to claim 1, wherein
the second mold includes a collar end surface contact surface to be in contact with the end surface of the tube portion, and a second cavity forming surface adjacent to the collar end surface contact surface and forming the cavity,
the second cavity forming surface is formed shallower than the collar end surface contact surface,
the pressing protrusion is formed protruding from the collar end surface contact surface,
the mold clamping step clamps the first mold and the second mold to bring the collar end surface contact surface into contact with the end surface of the tube portion, and
the molding step fills the cavity including the second cavity forming surface with the resin.

6. The method for manufacturing an insert molded article according to claim 2, wherein
the second mold includes a collar end surface contact surface to be in contact with the end surface of the tube portion, and a second cavity forming surface adjacent to the collar end surface contact surface and forming the cavity,
the second cavity forming surface is formed shallower than the collar end surface contact surface,
the pressing protrusion is formed protruding from the collar end surface contact surface,
the mold clamping step clamps the first mold and the second mold to bring the collar end surface contact surface into contact with the end surface of the tube portion, and
the molding step fills the cavity including the second cavity forming surface with the resin.

7. The method for manufacturing an insert molded article according to claim 3, wherein
the second mold includes a collar end surface contact surface to be in contact with the end surface of the tube portion, and a second cavity forming surface adjacent to the collar end surface contact surface and forming the cavity,
the second cavity forming surface is formed shallower than the collar end surface contact surface,
the pressing protrusion is formed protruding from the collar end surface contact surface,
the mold clamping step clamps the first mold and the second mold to bring the collar end surface contact surface into contact with the end surface of the tube portion, and
the molding step fills the cavity including the second cavity forming surface with the resin.

8. The method for manufacturing an insert molded article according to claim 4, wherein
the second mold includes a collar end surface contact surface to be in contact with the end surface of the tube portion, and a second cavity forming surface adjacent to the collar end surface contact surface and forming the cavity,
the second cavity forming surface is formed shallower than the collar end surface contact surface,
the pressing protrusion is formed protruding from the collar end surface contact surface,
the mold clamping step clamps the first mold and the second mold to bring the collar end surface contact surface into contact with the end surface of the tube portion, and
the molding step fills the cavity including the second cavity forming surface with the resin.

9. A mold for insert molding, the mold comprising:
a first mold including a placing surface on which an end surface of a metal collar on one side is placed such that an axis of a tube portion of the metal collar including the tube portion is along a mold clamping direction, and a first cavity forming surface adjacent to the placing surface; and
a second mold including an insertion portion formed in a columnar shape and to be inserted into an inside of the tube portion, a collar end surface contact surface provided outside the insertion portion in a radial direction and to be in contact with an end surface of the metal collar on another side, a pressing protrusion protruding from the collar end surface contact surface to be in contact with and press the end surface of the tube portion on the other side, and a second cavity forming surface adjacent to the collar end surface contact surface, wherein
the first cavity forming surface being formed shallower than the placing surface, and
the second cavity forming surface being formed shallower than the collar end surface contact surface.

10. The mold for insert molding according to claim 9, wherein
the second mold includes a piece member including the insertion portion, the collar end surface contact surface, and the pressing protrusion, and a second mold body provided with the piece member in a detachable manner and including the second cavity forming surface.

11. An insert molded article comprising:
a metal collar including a tube portion; and
a resin molded portion to which the metal collar is assembled, wherein
the tube portion including a recessed portion recessed from an end surface of the tube portion and an outer circumferential surface of the tube portion, and a locking protrusion protruding from the recessed portion outward in a radial direction of the tube portion to bite into the resin molded portion.
